(19) United States
(12) Patent Application Publication
(10) Pub. No.: US 2026/0104761 A1
(43) Pub. Date: Apr. 16, 2026

(54) ENVIRONMENTALLY ISOLATED KEYPAD ASSEMBLY WITH TACTILE FEEDBACK

(71) Applicant: AMETEK, INC., Berwyn, PA (US)

(72) Inventors: Chris R. Kolesar, North Huntingdon, PA (US); Nicole L. Rose, Monroeville, PA (US)

(73) Assignee: AMETEK, INC., Berwyn, PA (US)

(21) Appl. No.: 19/352,747

(22) Filed: Oct. 8, 2025

Related U.S. Application Data
(60) Provisional application No. 63/708,044, filed on Oct. 16, 2024.

(51) Int. Cl. G06F 3/03; G01D 5/30; G06F 3/01; G06F 3/02; H01H 13/702

(52) U.S. Cl. CPC G06F 3/0308; G01D 5/30; G06F 3/016; G06F 3/0202; H01H 13/702; H01H 2215/00

(57) ABSTRACT

An optical keypad assembly has a window, at least one array including a plurality of optical-sensing elements mounted on a printed circuit board, and a keypad membrane positioned on the window. The window has a seal to prevent ingress of contaminants into the enclosure. The keypad membrane includes a top surface and a bottom surface extending generally parallel to each other, a plurality of cutouts defining a respective target surface, at least one key each corresponding to the target surface or the plurality of optical-sensing elements, and at least one partition separating the adjacent cutouts, thereby mitigating sensitivity of the plurality of optical-sensing elements to interference. The keypad membrane overlies an entirety of the plurality of optical-sensing elements, thereby shielding them from ambient lighting. A plurality of channels connects the plurality of cutouts to reduce a press force applied to the at least one key.

### CROSS-REFERENCE TO RELATED APPLICATION

This application is a U.S. non-provisional patent application which claims priority to U.S. Provisional Application No. 63/708,044, filed Oct. 16, 2024, entitled “ENVIRONMENTALLY ISOLATED KEYPAD ASSEMBLY WITH TACTILE FEEDBACK,” the entire disclosure of which is incorporated by reference herein for all purposes.

### TECHNICAL FIELD

The present invention relates generally to keypad assemblies and more specifically, to a keypad interface with optical coupling for isolation of the electrically-active components, while providing a tactile response for the user.

### BACKGROUND

Equipment used in industrial applications is typically installed in locations where the surrounding atmosphere can pose problems for the operation of the equipment. Those problems include locations where the atmosphere contains agents or contaminants that might degrade the equipment (e.g., dust, debris, caustic or corrosive gases, liquids) and/or where the local atmosphere contains potentially flammable fuel-air mixtures that pose an ignition or detonation hazard. Protection of the instrumentation (i.e., the electrically active equipment) typically requires some type of isolation mechanism (e.g., water and dust proof enclosure seals, purging enclosures with an inert gas, etc.). Additionally, equipment may incorporate some form of human machine interface (HMI) to enable an operator to manually interact with the device. Such interfaces must be designed to successfully interface between the protected space within the enclosure and the ambient environment surrounding the instrumentation without subjecting the protected space to the environmental conditions.

HMIs used in most instrumentation or equipment typically contain two separate components: some form of visual display for the instrument to convey information to the user and an input device (e.g., switches, dials, keypads, touchscreens) for the user to input information into the instrumentation. Providing a protective barrier for the input device can be challenging. Non-limiting examples of conventional methods include the use of mechanical switches designed and rated for use in the specific ambient atmosphere, switches employing a magnetic coupling to transfer a mechanical action across an enclosure's wall or window, and optical devices to convey a signal through the window of an enclosure.

However, conventional optical switch and keypad technology has shortcomings. First, due to the separation between the optical sensors and their target (i.e., the operator's fingers), the size of the field required to define a single key within a keypad can be relatively large. Specifically, the uncertainty in the position of the target over the different keys within a keypad is defined by the resistance to crosstalk between optical-sensing elements; hence, the size of the keypad must be sufficiently large to accommodate the desired number of keys and the minimum size of each key to avoid overlap of optical responses and corresponding input errors. This situation is exacerbated for enclosures designed for use in hazardous areas, where the window intended to provide a protective barrier between the ambient environment and the display can have a thickness of over 1 centimeter, which increases the overall distance between the optical-sensing elements and the target. In many industrial installations the operator may be wearing gloves, which may necessitate an increase in the size of the optical target, requiring even larger areas to define a single “key” within the keypad. Another deficiency of current optical keypads is the sensitivity to background light levels. As an example, when conventional optical keypad designs are used in areas with direct sunlight, the ambient light can interfere with the optical sensing mechanism. Still another deficiency is the interference to some sensing mechanisms caused by “fouling” of the window with dirt and debris from the ambient environment. As material builds up on the window surface, the level of backscattered light from the sensing element increases, and in some instances, this high level of light backscatter is sufficient to interfere with the proper input of signals to the keypad. Further, conventional optical keypads do not provide the user with a tactile response to indicate that a key has been pressed.

Existing optical keypad technology does not address the above stated deficiencies. Existing optical keypad technologies are described, for example, in U.S. Pat. Nos. 4,254,333; 6,770,864; 9,553,597; WO 2017/102626 A1; U.S. Pat. No. 8,432,363; GB 2428503; DE 102022200966A1. Thus, there remains a need to provide an alternative or improved optical keypad that a) enables a protective seal to isolate electrically active components from the ambient atmosphere, b) provides a tactile response to the user, c) makes the optical sensing mechanism less sensitive to interferences (e.g., crosstalk between sensors, sensitivity to ambient light levels), or a combination thereof.

### SUMMARY

In one exemplary aspect, there is provided an optical keypad assembly. The optical keypad assembly includes a window having a first surface exposed to an exterior of the enclosure and a second surface exposed to the interior of the enclosure, a plurality of electrical components housed within the interior of an enclosure, and a keypad membrane positioned on the window. The plurality of electrical components includes a printed circuit board and at least one array mounted on the printed circuit board. The at least one array includes a plurality of optical-sensing elements. The keypad membrane includes a top surface and a bottom surface extending generally parallel to each other, a plurality of cutouts extending from the bottom surface with each having a respective target surface, and at least one key each having visible indicia disposed on the top surface. The at least one key and/or visible indicia disposed thereon is arranged in a pattern corresponding to the target surface or the respective location of the respective plurality of optical-sensing elements. The keypad membrane includes at least one partition separating adjacent cutouts, thereby mitigating sensitivity of the plurality of optical-sensing elements to interference due to optical crosstalk between adjacent plurality of optical-sensing elements. In particular, the plurality of optical-sensing elements is configured to monitor a predetermined characteristic of the respective target surface.

In another exemplary aspect, there is provided an optical keypad assembly. The optical keypad assembly includes a window having a first surface exposed to an exterior of the enclosure and a second surface exposed to the interior of the enclosure, a plurality of electrical components housed within the interior of the enclosure, and a keypad membrane. The plurality of electrical components includes a printed circuit board and at least one array mounted on the printed circuit board. The at least one array has a plurality of optical-sensing elements. The keypad membrane is positioned on the window and overlies an entirety of the plurality of optical-sensing elements, thereby shielding at least the plurality of optical-sensing elements from ambient lighting. In this way, interference (e.g. from ambient lighting) with the optical communication between the plurality of optical-sensing elements is mitigated.

Further, the keypad membrane has a top surface and a bottom surface extending generally parallel to each other and a plurality of cutouts with each having a respective target surface, with the plurality of optical-sensing elements configured to monitor a predetermined characteristic of the respective target surface. The keypad membrane includes at least one key, each having visible indicia disposed on the top surface and arranged in a pattern corresponding to the target surface or the respective location of the respective plurality of optical-sensing elements.

In still another exemplary aspect, there is provided an optical keypad assembly. The optical keypad assembly includes a window having a first surface exposed to an exterior of the enclosure and a second surface exposed to the interior of the enclosure, the window having a seal with the enclosure wall, thereby preventing ingress of contaminants into the interior of the enclosure. Additionally or optionally, a separate mechanism is used to secure the window to the enclosure wall. The optical keypad assembly also includes a plurality of electrical components housed within the interior of the enclosure and a keypad membrane. The plurality of electrical components includes a printed circuit board and at least one array mounted on the printed circuit board, with the at least one array including a plurality of optical-sensing elements. The keypad membrane includes a top surface and a bottom surface extending generally parallel to each other and a plurality of cutouts extending from the bottom surface, with each having respective target surface, with the plurality of optical-sensing elements configured to monitor a predetermined characteristic of the respective target surface. The keypad membrane also has at least one key, each having visible indicia disposed on the top surface and arranged in a pattern corresponding to the target surface or the respective location of the respective plurality of optical-sensing elements.

In yet another exemplary aspect, there is provided a method of interacting with an enclosure installed in a hazardous environment using a human machine interface (HMI). The method includes the step of providing an optical keypad assembly. The optical keypad assembly has a window having a first surface exposed to an exterior of the enclosure and a second surface exposed to the interior of the enclosure, printed circuit board, and at least one array mounted on the printed circuit board. The at least one array includes a plurality of optical-sensing elements. The optical keypad assembly includes a keypad membrane. The keypad membrane includes a top surface and a bottom surface extending generally parallel to each other, a plurality of cutouts extending from the bottom surface with each having a respective target surface, and at least one key, each having visible indicia disposed on the top surface.

The method includes the step of providing an input comprising a press force applied to the at least one key for a duration, thereby causing a displacement of at least the target surface; detecting, via the plurality of optical-sensing elements, the displacement of at least the target surface; providing a tactile feedback from the keypad membrane in response to the input; and detecting a liftoff from the at least one key, thereby causing another displacement of at least the target surface of the keypad membrane. In particular, the tactile feedback includes a localized deformation of at least the respective target surface that received the press force.

### BRIEF DESCRIPTION OF THE DRAWINGS

The invention is best understood from the following detailed description when read in connection with the accompanying drawings, with like elements having the same reference numerals. When a plurality of similar elements is present, a single reference numeral may be assigned to the plurality of similar elements with a small letter designation referring to specific elements. When referring to the elements collectively or to a non-specific one or more of the elements, the small letter designation may be omitted. In addition, according to common practice, the various features of the drawings are not drawn to scale unless otherwise indicated, and the dimensions of the various features may be expanded or reduced for clarity. Included in the drawings are the following figures:

FIGS. 1A-1B depict diagrams of an enclosure including an exemplary optical keypad assembly.

FIG. 2A is a side view of a portion of the assembled exemplary optical keypad assembly.

FIG. 2B is a section view of a portion of the assembled exemplary optical keypad assembly of FIG. 2A.

FIG. 3 depicts a portion of the enclosure having an exemplary optical keypad assembly.

FIG. 4 is an exploded view of an exemplary optical keypad assembly configured to be installed to a panel or wall of an enclosure.

FIG. 5A depicts a portion of a panel or wall of an enclosure showing an exemplary optical keypad assembly installed in association with the enclosure.

FIG. 5B is an exploded view of the enclosure and optical keypad assembly of FIG. 5A.

FIG. 6A depicts an exemplary printed circuit board and exemplary arrays of optical-sensing elements.

FIG. 6B depicts a section view of optical-sensing elements of FIG. 6A.

FIG. 7A is a front perspective view of an exemplary keypad membrane.

FIG. 7B is a rear perspective view of the keypad membrane of FIG. 7A.

FIG. 8A is a graphic illustration of an optical signal(s) received by the optical detector.

FIG. 8B is a graphic illustration of the electrical signal(s) created in response to a press force for a duration applied to the keypad membrane or portions thereof.

FIG. 9A is a graphic illustration of an optical signal(s) received by the optical detector.

FIG. 9B is a graphic illustration of the electrical signal(s) created in response to a press force for another duration applied to the keypad membrane or portions thereof.

FIG. 10 depicts an exemplary method of interacting with an enclosure installed in a hazardous environment using a human machine interface (HMI).

### DETAILED DESCRIPTION

The optical keypad assemblies disclosed herein are usable for various types of equipment, including equipment that includes a human machine interface (HMI) and/or equipment installed in various hazardous environments or conditions (e.g. as defined by ATEX Directive 94/9/EC, ATEX/IEC/UL 60079-1, or like industry standards). The exemplary optical keypad assemblies described herein may be mounted to a panel or wall of enclosures (installed in hazardous conditions or environments), and one skilled in the art would understand from the description that mounting or installation mechanisms may vary depending on the type of equipment or type of environment or ambient atmosphere associated with the type of equipment. Thus, aspects of the present invention are usable in applications in which a human machine interface (HMI) and/or equipment installed in various hazardous environments or conditions are desired.

Generally, the present invention relates to an optical keypad assembly designed for operation through a glass window (e.g. thick glass window). The optical keypad assembly incorporates a tactile overlay that allows users to actuate buttons or keys situated outside the glass window to interact with the user interface inside an enclosure behind the glass window. The invention has multiple applications, including but not limited to environments with hazardous or potentially hazardous gases present, thereby eliminating the need to open enclosures, obtain hot work permits, or shut down processes to interact with the internal system.

In general, the present invention is directed to an optical keypad assembly or apparatus. Advantages of the present invention include use of a keypad membrane (e.g. a flexible keypad membrane) that is exposed to the ambient environment (e.g. a hazardous environment or condition) on the keypad side of the membrane, while electrical components are housed within the enclosure, thereby mitigating exposure for the electrical components to contaminants such as dirt, debris, and other media that could potentially interrupt proper transmission of signals among one or more electrical components. Unlike conventional optical keypad assemblies, the use of the inventive flexible keypad membrane provides the user with a tactile feedback (e.g. providing a tactile response when a key is pressed) with the sensor coupling being purely optical. The keypad membrane also provides shielding of the electrical components from the ambient environment, thereby reducing or mitigating sensitivity to interference caused by high ambient light levels. With all the electrically active components of the optical keypad assembly contained within the enclosure, and isolated from the ambient environment, the inventive optical keypad assembly is suitable for installation and use in many hazardous environments.

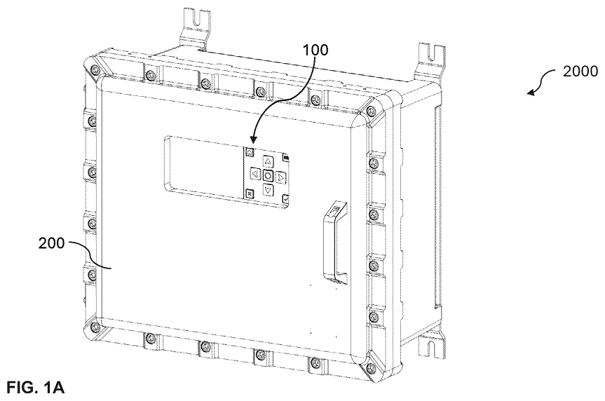

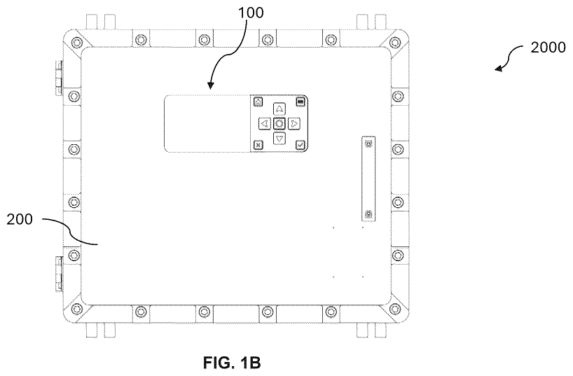

There is shown in FIGS. 1A-1B an enclosure 2000 having an interior space that can be sealed from the ambient conditions surrounding enclosure 2000 while being accessible through a door 200 or other sealable opening. Enclosure 2000 also includes an exemplary optical keypad assembly 100. In an exemplary embodiment, enclosure 2000 includes a human machine interface (HMI) and can be installed in various hazardous environments or conditions (e.g. as defined by ATEX Directive 94/9/EC, ATEX/IEC/UL 60079-1, or like industry standards). Optical keypad assembly 100 is shown mounted to door/panel 200 or a wall of enclosures 2000. Optical keypad assembly 100 can be mounted to any surface of enclosure 2000 as may be required or desired for a particular situation or application.

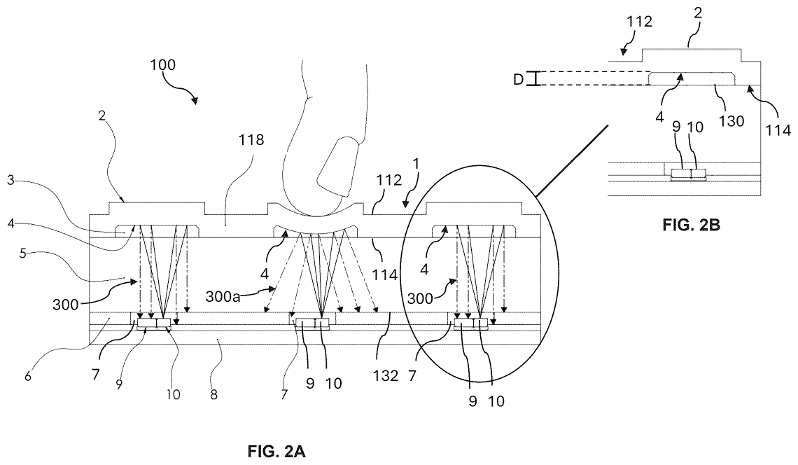

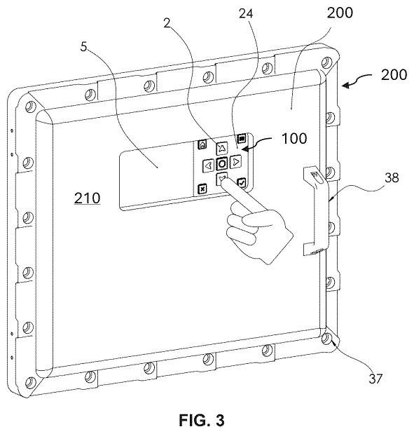

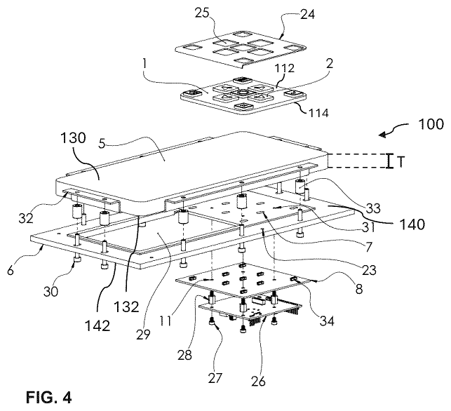

There is shown in FIGS. 2A-2B, 3, 4, and 5A-5B an exemplary optical keypad assembly 100. Optical keypad assembly 100 has many applications, including use for flameproof enclosures, which require a type “d” protection in hazardous areas (i.e., ATEX/IEC/UL 60079-1, etc.). Optical keypad assembly 100 has a window 5 with a first surface 130 (FIG. 4) and a second surface 132 (FIG. 4), a plurality of electrical components housed within the interior space of enclosure 2000, and a keypad membrane 1 mounted on first surface 130 and positioned on or accessible through exterior surface 210 (FIG. 3) of enclosure 2000. In an exemplary embodiment, keypad membrane 1 is opaque and/or is comprised of a flexible or deformable material. Keypad membrane 1 includes a top surface 112 and a bottom surface 114 (FIG. 2A) extending generally parallel to each other. Keypad membrane 1 includes projections or keys 2 on or extending from top surface 112. Bottom surface 114 faces and is generally in contact with first surface 130 of window 5. Keypad membrane 1 also includes a plurality of cutouts or chambers 3 extending from bottom surface 114 to a distance D (FIG. 2B). Each cutout includes a respective target surface 4. Target surface 4 is generally parallel to window first surface 130 (FIG. 4) when a key 2 is not depressed. In an exemplary embodiment, when a key 2 is displaced or depressed, target surface 4 transitions to an approximately convex shape as shown in FIG. 2A. Additionally or optionally, target surface 4 is positioned at a location proximate to a center of corresponding key 2.

The plurality of electrical/electronic components shown in this exemplary embodiment include a printed circuit board 8 and at least one array 10 including a plurality of optical-sensing elements 34 (FIG. 4) mounted on circuit board 8. In an exemplary embodiment, plurality of optical-sensing elements 34 comprises one or more optical switches. Plurality of optical-sensing elements 34 includes at least one pair of optical emitter 10 and optical detector 9. As shown in FIG. 2A, each of the plurality of optical-sensing elements 34 on printed circuit board 8 fits into a corresponding aperture 7 of a mounting plate 6. Apertures 7 function as channels that facilitate and enable optical communication between the plurality of optical-sensing elements 34 and a void or space above mounting plate 6 directly over each of the plurality of optical-sensing elements 34. In this way, keys 2 on top or first surface 112 of keypad membrane 1 is aligned over plurality of optical-sensing elements 34 mounted on printed circuit board 8, such that the pairs of optical emitter 10 and optical detector 9 are in optical communication with second surface 114 of keypad membrane 1, at a location proximate to respective target surface 4 of corresponding key 2. Electromagnetic radiation is emitted by each optical emitter 10, which then travels through corresponding aperture 7, then passes through window 5, and illuminates respective target surface 4 of corresponding key 2. A portion of the electromagnetic radiation illuminating target surface 4 of each key 2 is scattered back and passes through window 5 and aperture 7 (as shown via arrows 300, 300a in FIG. 2A), falling incident on optical detector 9, wherein the electromagnetic radiation entering the optical detector 9 is then converted into an electrical signal. In this way, plurality of optical-sensing elements 34 is configured to monitor a predetermined characteristic of respective target surface 4 defined beneath each corresponding key 2.

As will be explained later below, the predetermined characteristic of target surface 4 includes a change in intensity of a portion of the electromagnetic radiation scattered from target surface 4 in response to the displacement (e.g. change in distance “D” of FIG. 2B) of at least target surface 4 of keypad membrane 1. This resulting change in intensity of the electromagnetic radiation entering optical detector 9, produces a change in the magnitude of the electrical signal. Specifically, when key 2 is pressed, the pattern of the scattered electromagnetic radiation is widened, as illustrated by arrows 300a in FIG. 2A, resulting in a decrease in the electromagnetic radiation intensity observed by corresponding optical detector 9. This decrease in the signal intensity is in contrast to conventional optical keypads that detect an input, e.g., the presence of or contact with a finger at a conventional key location, as an increase in the optical intensity received by an optical detector in a conventional optical keypad.

As shown in FIG. 3, optical keypad assembly 100 is mounted to door/panel 200 or wall of enclosure 2000 via known mounting or installation mechanisms. In one non-limiting example, a pattern of bolt holes 37 is configured to facilitate a mounting mechanism (e.g. nuts/bolts) for securing the panel or door 200 to enclosure 2000. However, one skilled in the art would understand from the description herein that the mounting mechanism is not so limited and will depend on design criteria, such as the type of enclosure 2000 and/or installation conditions desired. At least keypad membrane 1 is visible through an opening defined by exterior surface 210 of enclosure 2000 that is sufficient for an optical signal to be transmitted between keys 2 and optical-sensing elements 34. In this way, a user has access to operate optical keypad assembly 100 without having to open or otherwise compromise the predetermined method of protection for the interior of enclosure 2000. Additionally, or optionally, the user can view, via a portion of window 5, information from a display module of the HMI. As discussed above, optical keypad assemblies 100 are usable for various types of equipment, including equipment installed in various hazardous environments or conditions. For example, window 5 used in type “d” enclosures must have sufficient thickness T (FIG. 4) for use in hazardous area installations (i.e., ATEX Directive 94/9/EC and similar) or certain conditions (e.g. withstand the force of a detonation event), and thus, window 5 can be greater than one centimeter thick. Thus, the separation or distance between optical-sensing elements 34 and the respective target surfaces 4 is generally greater (due to the thickness of window 5) than that of typical optical keypads.

To account for this separation or distance, partitions 118 (FIG. 2A) between adjacent cutouts 3 of keys 2 are provided to minimize optical crosstalk between optical-sensing elements 34. In operation, each key 2 and corresponding target surface 4 serves as an “optical target” for a corresponding optical-sensing element 34. Advantageously, having at least one partition 118 to separate adjacent plurality of cutouts 3 mitigates or reduces sensitivity of optical-sensing elements 34 to interference due to optical crosstalk between adjacent optical-sensing elements 34. In this way, keypad membrane 1 provides improved optical isolation between different keys 2 (via partition or wall 118), such that more closely spaced keys 2 (relative to other keys 2) may be used, for example. In an exemplary embodiment, static-dissipative overlay 24 (FIG. 4) is affixed or to top surface 112 of keypad membrane 1, particularly in portions of keypad membrane 1 where the buildup of static charge is not desired. In this way, static-dissipative overlay 24 is positioned over potions of keypad membrane 1, thereby permitting use of the optical keypad assembly 100 in a hazardous environment. In one non-limiting example, optical keypad assembly 100 is mounted to or disposed on door 200 of flameproof enclosure 2000. Additionally or optionally, a handle 38 (FIG. 3) of enclosure 2000 is provided.

Referring to FIG. 4, window 5 includes first surface 130 exposed to or facing towards an exterior of enclosure 2000 and second surface 132 opposite first surface 130. Window 5 may have a thickness (T) (FIG. 4) that can vary based on the specific requirements of installation or hazardous use conditions/environments. Keypad membrane 1 is positionable on a portion of window 5, such that bottom surface 114 is in contact with first surface 130 of window 5. Keypad membrane 1 includes projections or keys 2 on or extending from top surface 112. As discussed above, static-dissipative overlay 24 is affixed or to top surface 112 of keypad membrane 1, such that a plurality of openings 25 formed by overlay 24 is aligned directly over corresponding key 2 positions. In this configuration, keys 2 are adapted to project or extend through openings 25 so that keys 2 can be activated or accessed by a user.

Window 5 is affixed to mounting plate 6 via known attachment mechanisms, such as with nuts/bolts. However, one skilled in the art would understand from the description herein that the window 5 may be mounted or secured to the enclosure 2000 via various known mechanisms, the selection of which may depend in part on design criteria, such as the type of enclosure 2000 and/or installation conditions desired. In one non-limiting example, mounting plate 6 is used to hold both optical keypad assembly 100 and an optional display module (not shown), which would be mounted behind a display opening 29, using a set of mounting holes 23 on mounting plate 6. Mounting plate 6 has a pattern of apertures 7, each aperture 7 being proximate to and aligned with corresponding pairs of optical emitter 10 and optical detector 9 of plurality of optical-sensing elements 34. This arrangement enables optical emitter 10 and optical detector 9 to be in communication with a void or space directly above aperture 7 on an opposite or other side of mounting plate 6. Second surface 132 of window 5 is positioned proximate to a first surface 140 of mounting plate 6, and printed circuit board 8 is positioned proximate to a second surface 142 of mounting plate 6. In an exemplary embodiment, printed circuit board 8 is affixed to mounting plate 6, using male-female standoffs 28 and a pattern of mounting holes 11 on printed circuit board 8, which is designed to match the pattern of plurality of mounting holes 31 on mounting plate 6. A corresponding hole pattern is used on a second printed circuit board 26, which contains signal-processing electronics for optical keypad assembly 100. Printed circuit board 26 is affixed to at least printed circuit board 8 by a set of screws 27, which are fastened to sets of male-female standoffs 28. Window-mounting brackets 32 are used to secure window 5 to an inside surface of enclosure 2000, with mounting plate 6 being secured to window-mounting bracket 32. Securing window-mounting bracket 32 and mounting bracket 6 is accomplished via known attachment mechanisms, such as bolts 30 which are anchored into a wall of enclosure 2000. Spacers 33 are used to provide a gap between the window-mounting brackets 32 and mounting plate 6.

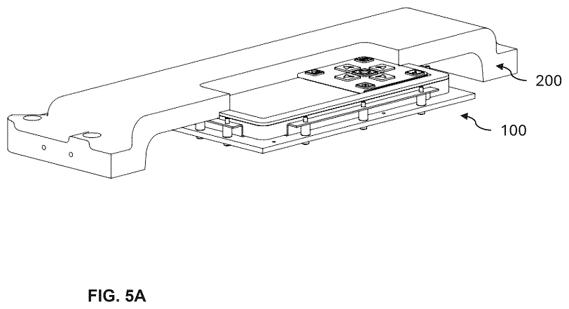

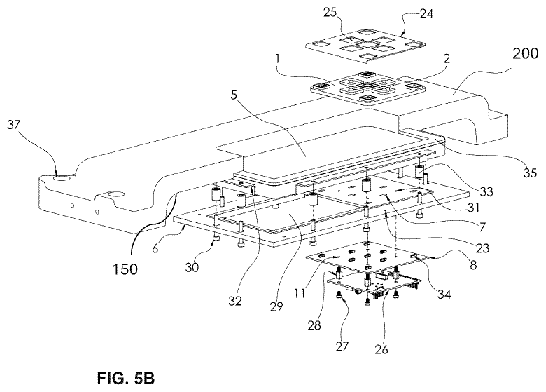

Referring now to FIGS. 5A-5B, optical keypad assembly 100 is mounted to or disposed on door 200 of a flameproof enclosure 2000 in a similar fashion as described above with respect to at least FIG. 4. However, this embodiment differs in some respects (relative to the embodiments discussed above). In a non-limiting example, a the window 5 has a seal 35 with at least one wall of the enclosure 2000 in an exemplary embodiment, seal 35 is used or applied between first surface 130 of the window 5 and an interior surface 150 of door 200. Seal 35 prevents the ingress of contaminants from the ambient atmosphere (e.g., gases, dust, etc.) into the interior space of flameproof enclosure 2000. In one non-limiting example, seal 35 comprises a hermetic seal, thereby preventing ingress of contaminants into the interior space of enclosure 2000.

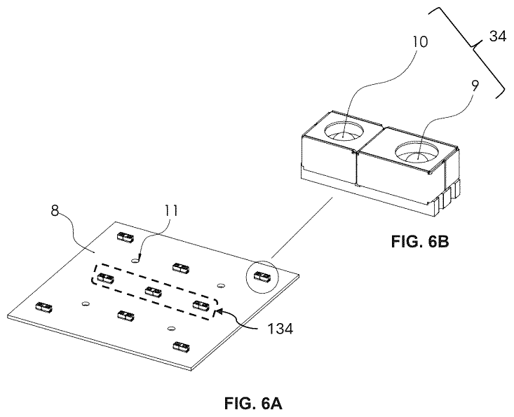

Turning now to FIGS. 6A-6B, optical-sensing elements 34 are configured to monitor a predetermined characteristic of respective target surfaces 4. As discussed above, mounted on printed circuit board 8 is at least one array 134 including plurality of optical-sensing elements 34. In an exemplary embodiment, each optical-sensing element 34 include at least one pair of optical emitter 10 and optical detector 9, with each pair arranged in a pattern on printed circuit board 8. Each optical-sensing element corresponds to specific key 2 on keypad 1. One skilled in the art would understand that the arrangement of the plurality of optical-sensing elements 34 and keys 2 are not limited to that shown in the figures, but the arrangement of said components is based on or specific to the HMI of the desired application, for example. Still further, each optical-sensing element 34 is shown as a monolithic component, with the combination of optical emitter 10 and optical detector 9 mounted into a single module. Optical-sensing elements 34 are not so limited and may include discrete or separate optical emitters 10 and optical detectors 9. In addition, printed circuit board 8 is affixed to other components of optical assembly 100, such as mounting plate 6 discussed above, using a pattern of mounting holes 11 on printed circuit board 8, which is designed to match the pattern of mounting holes 31 on mounting plate 6 (FIGS. 4 and 5B). The number and location of mounting holes 11 for printed circuit board 8 as illustrated in the figures are not intended to be limiting.

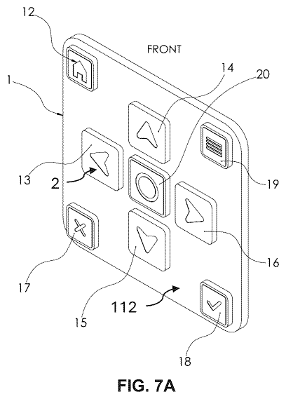

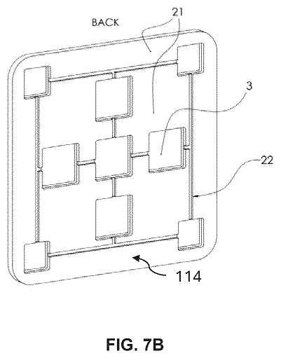

As shown in FIG. 7A, keypad membrane 1 also has visible indicia (12, 13, 14, 15, 16, 17, 18, 19, 20) disposed on projections or keys 2 on top surface 112. In an exemplary embodiment, FIG. 7A depicts a front perspective view of keypad membrane 1, particularly of top surface 112 defining nine separate keys 2. Each key 2 corresponds to respective optical-sensing element 34 mounted on printed circuit board 8. In one non-limiting example, keys 2 are projections extending from top surface 112. Keys 2 may be disposed flush (flat) on top surface 112. In one non-limiting example, nine separate keys 2 and with different visible indicia are shown: a “Home” key 12, a “Left-Arrow” key 13, an “Up-Arrow” key 14, a “Down-Arrow” key 15, a “Right-Arrow”key 16, a “Cancel” key 17, an “Accept” key 18, a “Menu” key 19 and an “Enter” key 20. However, the invention is not so limited to the arrangement, type, or number of keys 2 or visible indicia. Instead, characteristics of keys 2 and visible indicia can be varied within the scope of the invention in order to meet the requirements of different HMIs or applications. For example, keys 2 may display alphanumeric characters, symbols, images, icons, non-text graphics, or combinations thereof. In particular the visible indicia of keys 2 may include numeric values (e.g., 1, 2, 3, etc.), alphabetical character (e.g., A, B, C, etc.), or functional designations (e.g., Home, Menu, Enter, etc.). Each one of keys 2 has a corresponding target surface 4 underneath (FIG. 2) and is arranged in a pattern that aligns each target surface 4 and a corresponding optical-sensing element 34. Thus, keypad membrane 1 includes a plurality of projections 2 and visible indicia (12, 13, 14, 15, 16, 17, 18, 19, 20) aligned with and positioned over a respective plurality of projections 2. In this way, a position of key 2 is completely defined by keypad membrane 1, so there is little or no uncertainty on exactly where a finger (or other like object) should be placed as an input to trigger the response (or output) from the desired optical switch.

FIG. 7B illustrates a rear perspective view of keypad membrane 1 showing bottom surface 114, with plurality of cutouts or chambers 3 formed in alignment with keys 2. Each chamber 3 formed on bottom surface 114 of keypad membrane 1 corresponds to specific key 2 on top surface 112, with a central region of each chamber 3 located proximate to a central region of corresponding key 2. Each of chambers 3 are connected by channels 22, which increases the total volume of the confined airspace (i.e., the airspace sealed between first surface 130 of a window 5, as shown in FIG. 4, and bottom surface 114 of keypad membrane 1), thereby (1) reducing the pressure increase created when individual key 2 receives or experiences a press force (e.g. pressed) for a duration and (2) reducing the force required to press key 2. While both keys 2 and chambers 3 are illustrated in the figures as having a generally rectangular geometry, one skilled in the art would understand that other geometries for keys 2 and/or chambers 3 are within the scope of the invention based on the desired application. An adhesive layer 21 may be used to affix keypad membrane 1 to top surface 130 of window 5, but other known attachment mechanisms (e.g. use of mechanical hardware) can be used to affix keypad membrane 1 to top surface 130 of window 5. In an exemplary embodiment with keypad membrane 1 physically affixed to top surface 130 of window 5, contaminants such as dust and dirt are prevented from fouling top surface 130 of window 5 and interfering with the optical communication between optical emitters 10 and optical detectors 9.

In operation, keypad membrane 1 provides tactile feedback to a user of optical key assembly 100 in response to an input. One skilled in the art would understand from the description herein that other types of feedback, in addition to tactile feedback, may be implemented, including for example, auditory (e.g. click), haptic (e.g. vibration), visible (e.g. LED, etc.) types of feedback. In one non-limiting example, the input comprises a press force (e.g. pressing) applied to at least one key 2 for a duration, thereby causing a displacement (e.g. change in D of FIG. 2B) of at least target surface 4 of keypad membrane 1 in response to the press force. Thus, applying the press force (e.g. pressing) to key 2 on keypad membrane 1 creates a localized deformation or displacement (e.g. due to change of D in FIG. 2B) of at least target surface 4 of key 2, resulting in a change in the intensity pattern of electromagnetic radiation scattered from target surface 4. In this way, the predetermined characteristic of target surface 4, as monitored via plurality of optical-sensing elements 34, includes a change in intensity of a portion of the electromagnetic radiation scattered from target surface 4 in response to the displacement of at least target surface 4 of keypad membrane 1. This resulting change in intensity of the electromagnetic radiation entering the optical detector 9, produces a change in the magnitude of the electrical signal. Specifically, when key 2 is pressed for a duration, the pattern of the scattered electromagnetic radiation is widened, as illustrated by arrows 300a in FIG. 2, resulting in a decrease in the electromagnetic radiation intensity observed by the optical detector 9.

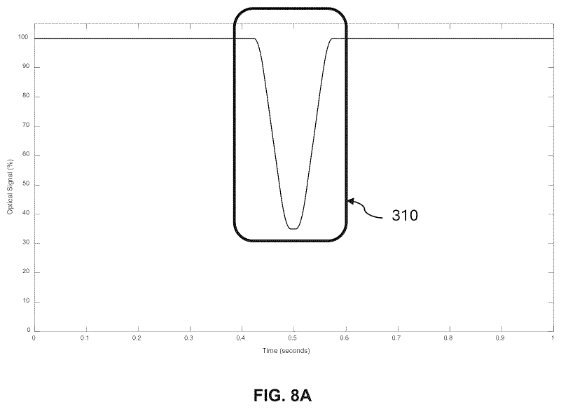

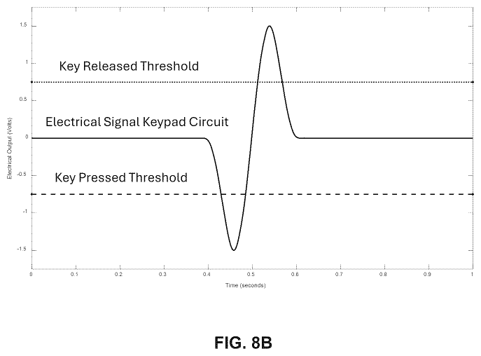

As shown in FIG. 8A, optical signals corresponding to an event or action of applying a press force to key(s) 2 for a duration (e.g. “pressing a key”) are provided. Prior to key 2 being pressed, or at an equilibrium state of keypad membrane 1, optical intensity as detected by plurality of optical-sensing elements 34 (in association with a predetermined characteristic of target surface 4) maintains a constant value. Once pressure is exerted or applied on key 2 (e.g. via contact or force applied with user's finger), target area 4 starts to deform (e.g. a displacement or change in D (FIG. 2B) of target area 4), thereby decreasing the amount of scattered radiation received or detected by optical detector 9. As pressure on key 2 is released (e.g. a liftoff action or event), the deformation of key 2 subsides (or another displacement of target surface 4 occurs or is observed) and the level of scattered radiation received by the optical detector 9 increases, until the level reaches the equilibrium or constant value. One skilled in the art would understand from the description herein that the magnitude of the optical signals shown in FIG. 8A are relative values, with a value of 100% assigned to the nominal condition, and the magnitude of the drop (identified by a box 310 in the graph of FIG. 8A) in intensity is non-limiting.

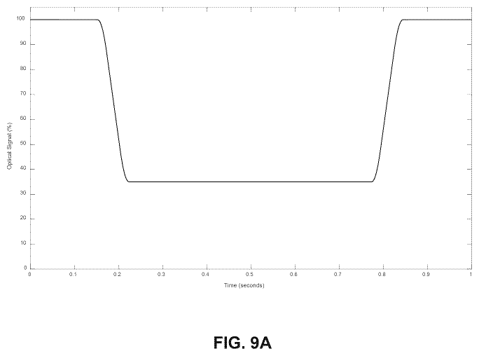

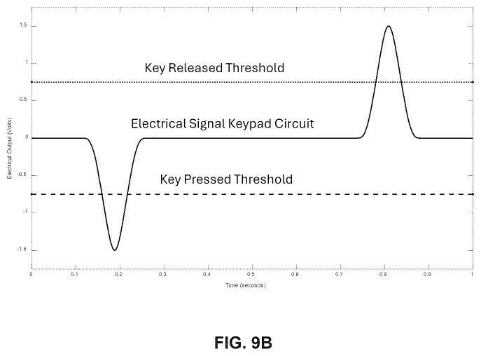

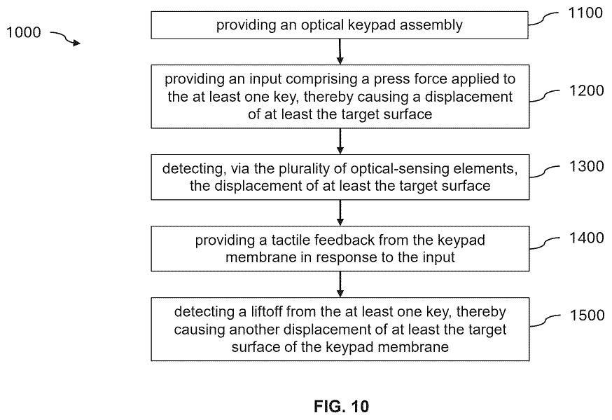

Optical detectors 9 of optical keypad assembly 100 are connected to an electrical circuit (not shown), which processes the electrical signals and is mounted on second printed circuit board 26 (FIGS. 4 and 5B). In particular, optical keypad assembly 100 has an electrical circuit coupled to a plurality of electrical components, with the electrical circuit configured to process electrical signals generated by plurality of optical-sensing elements 34. In an exemplary embodiment, the electrical circuit is AC-coupled, and the output signal of the electrical circuit approximates the first derivative of the optical signal. A plot of the output from the electrical circuit is illustrated in FIG. 8B. As with the optical-signal levels, one skilled in the art would understand that the magnitude of the electrical signals and the triggering thresholds for detecting “key 2 pressed” (e.g. application of a press force) and “key 2 released” (e.g. liftoff) events, as shown in FIG. 8B are not intended to be limiting, since different signal levels and threshold values can vary based on the desired application. Further, the timescale associated with the “key-pressed” and “key-released” events in FIG. 8B is also intended to be illustrative, such that relatively shorter or longer timescales can be used. For example, FIGS. 9A-9B illustrate both the optical (FIG. 9A) and electrical (FIG. 9B) signals produced in association with the “key-pressed” and “key-released” events according to a different timescale, such as when a key is pressed, held for a duration (e.g. momentarily), and finally released.

An exemplary method of interacting with an enclosure 2000 installed in a hazardous environment using HMI, such as method 1000, is provided and is consistent with the operation described above. Generally, method 1000 includes steps of providing an optical keypad assembly; providing an input comprising a press force applied to the at least one key, thereby causing a displacement of at least the target surface; detecting, via the plurality of optical-sensing elements, the displacement of at least the target surface; receiving a tactile feedback from the keypad membrane in response to the input; and detecting a liftoff from the key or visible indicia, thereby causing another displacement of at least the target surface of the keypad membrane.

Specifically, step 1100 includes providing an optical keypad assembly, such as optical keypad assembly 100. In an exemplary embodiment, optical keypad assembly 100 includes window 5 having a first surface 130 exposed to an exterior of enclosure 2000 and a second surface 132 exposed to an interior of enclosure 2000. Optical keypad assembly 100 also has a keypad membrane 1 and at least one array 134 including a plurality of optical-sensing elements 34 mounted on printed circuit board 8. Keypad membrane 1 includes top surface 112 and bottom surface 114 extending generally parallel to each other; a plurality of cutouts 3 extending from bottom surface 114 until a distance (D in FIG. 2B) from the top surface 112 and defining respective target surface 4; and at least one key 2 having visible indicia disposed on top surface 112.

Step 1200 includes providing an input comprising a press force applied to the at least one key 2, thereby causing a displacement (change in D in FIG. 2B) of at least target surface 4. In this way, as indicated by step 1300, the displacement of at least the target surface 4 is detected via the plurality of optical-sensing elements 34. In a non-limiting example, the plurality of optical-sensing elements 34 includes an optical emitter 10 configured to emit electromagnetic radiation to illuminate at least the target surface 4, such that the displacement of at least target surface 4 (e.g. indicated by a change in D in FIG. 2B) causes a change in intensity of a portion of the electromagnetic radiation scattered from the target surface 4, which is detectable by optical detector 9.

Step 1400 includes receiving a tactile feedback from the keypad membrane in response to the input. In an exemplary embodiment, the tactile feedback includes a localized deformation (e.g. displacement or change in D in FIG. 2B) of at least respective target surface 4 to which a press force is applied (e.g. via key 2) for a duration. Then, as indicated in step 1500, a liftoff from the key(s) 2 is detected, thereby causing another deformation or displacement of at least target surface 4 of keypad membrane 1. Similar to steps 1200-1300, the displacement of at least target surface 4 causes a change in intensity of a portion of the electromagnetic radiation scattered from the target surface 4, which is detectable by optical detector 9.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. An optical keypad assembly comprising:
a window having a first surface exposed to an exterior of the enclosure and a second surface exposed to the interior of the enclosure;
a plurality of electrical components housed within the interior of an enclosure, the plurality of electrical components comprising:
a printed circuit board, and
at least one array mounted on the printed circuit board, the at least one array including a plurality of optical-sensing elements;
a keypad membrane positioned on the window, the keypad membrane comprising:
a top surface and a bottom surface extending generally parallel to each other,
a plurality of cutouts extending from the bottom surface with each having a respective target surface, the plurality of optical-sensing elements configured to monitor a predetermined characteristic of the respective target surface,
at least one key each having a visible indicia disposed on the top surface and arranged in a pattern corresponding to the target surface or the respective location of the respective plurality of optical-sensing elements, and
at least one partition separating adjacent cutouts, thereby mitigating sensitivity of the plurality of optical-sensing elements to interference due to optical crosstalk between adjacent plurality of optical-sensing elements.

2. The optical keypad assembly of claim 1, wherein the keypad membrane provides tactile feedback in response to an input.

3. The optical keypad assembly of claim 2, wherein the input comprises a press force applied to the key for a duration, thereby causing a displacement of at least the target surface of the keypad membrane in response to the press force.

4. The optical keypad assembly of claim 3, wherein the tactile feedback comprises a localized deformation of at least the respective target surface that received the press force.

5. The optical keypad assembly of claim 3, wherein the plurality of optical-sensing elements comprises an optical switch.

6. The optical keypad assembly of claim 5, wherein the plurality of optical-sensing elements comprises at least one pair of an optical emitter and an optical detector, the optical emitter configured to emit electromagnetic radiation to illuminate at least the target surface.

7. The optical keypad assembly of claim 6, wherein the predetermined characteristic of the target surface comprises a change in intensity of a portion of the electromagnetic radiation scattered from the target surface in response to the displacement of at least the target surface of the keypad membrane.

8. The optical keypad assembly of claim 7, wherein the change in intensity comprises a decrease in intensity as detected by the optical detector.

9. The optical keypad assembly of claim 1, further comprising an electrical circuit coupled to the plurality of electrical components, the electrical circuit configured to process electrical signals generated by the plurality of optical-sensing elements.

10. The optical keypad assembly of claim 1, further comprising a static-dissipative overlay positioned over potions of the keypad membrane, thereby permitting use of the optical keypad assembly in a hazardous environment.

11. The optical keypad assembly of claim 10, wherein the keypad membrane comprises a plurality of projections and the visible indicia is aligned with and positioned over the plurality of projections.

12. The optical keypad assembly of claim 11, wherein the static-dissipative overlay comprises a plurality of openings through which the plurality of projections extends.

13. The optical keypad assembly of claim 1, wherein the window is secured to the enclosure and has a seal to prevent ingress of the ambient atmosphere.

14. The optical keypad assembly of claim 13, wherein the seal comprises a hermetic seal, thereby preventing ingress of contaminants into the interior of the enclosure.

15. The optical keypad assembly of claim 1, wherein the visible indica comprises alphanumeric characters, symbols, images, icons, non-text graphics, or combinations thereof.

16. The optical keypad assembly of claim 1, wherein the keypad membrane is opaque.

17. The optical keypad assembly of claim 1, wherein the optical keypad assembly is installed in a hazardous environment.

18. An optical keypad assembly comprising:
a window having a first surface exposed to an exterior of the enclosure and a second surface exposed to the interior of the enclosure;
a plurality of electrical components housed within the interior of an enclosure, the plurality of electrical components comprising:
a printed circuit board, and
at least one array mounted on the printed circuit board, the at least one array including a plurality of optical-sensing elements;
a keypad membrane positioned on the window and overlying an entirety of the plurality of optical-sensing elements, thereby shielding at least the plurality of optical-sensing elements from ambient lighting, the keypad membrane comprising:
a top surface and a bottom surface extending generally parallel to each other,
a plurality of cutouts extending from the bottom surface with each having a respective target surface, the plurality of optical-sensing elements configured to monitor a predetermined characteristic of the respective target surface, and
at least one key, each having visible indicia disposed on the top surface and arranged in a pattern corresponding to the target surface or the respective location of the respective plurality of optical-sensing elements.

19. An optical keypad assembly comprising:
a window having a first surface exposed to an exterior of the enclosure and a second surface exposed to the interior of the enclosure, the window being secured to the enclosure and having a seal to prevent ingress of contaminants into the interior of the enclosure;
a plurality of electrical components housed within the interior of an enclosure, the plurality of electrical components comprising:
a printed circuit board, and
at least one array mounted on the printed circuit board, the at least one array including a plurality of optical-sensing elements;
a keypad membrane comprising:
a top surface and a bottom surface extending generally parallel to each other,
a plurality of cutouts extending from the bottom surface with each having a respective target surface, the plurality of optical-sensing elements configured to monitor a predetermined characteristic of the respective target surface, and
at least one key, each having visible indicia disposed on the top surface and arranged in a pattern corresponding to the target surface or the respective location of the respective plurality of optical-sensing elements.

20. The optical keypad assembly of claim 19, wherein the keypad membrane further comprises a plurality of channels connecting the plurality of cutouts to increase a total volume of confined airspace sealed between a first surface portion of the window and bottom surface of the keypad membrane, thereby reducing a press force applied to the at least one key.

21. A method of interacting with an enclosure installed in a hazardous environment using a human machine interface (HMI), the method comprising:
providing an optical keypad assembly comprising:
a window having a first surface exposed to an exterior of the enclosure and a second surface exposed to an interior of the enclosure;
a printed circuit board,
at least one array mounted on the printed circuit board, the at least one array including a plurality of optical-sensing elements, and
a keypad membrane comprising:
a top surface and a bottom surface extending generally parallel to each other,
a plurality of cutouts extending from the bottom surface with each having a respective target surface, and
at least one key, each having visible indicia disposed on the top surface;
providing an input comprising a press force applied to the at least one key for a duration, thereby causing a displacement of at least the target surface;
detecting, via the plurality of optical-sensing elements, the displacement of at least the target surface;
providing a tactile feedback from the keypad membrane in response to the input, the tactile feedback comprising a localized deformation of at least the respective target surface that received the press force; and
detecting a liftoff from the at least one key, thereby causing another displacement of at least the target surface of the keypad membrane.
